(19) United States
(12) Patent Application Publication
(10) Pub. No.: US 2019/0011329 A1
(43) Pub. Date: Jan. 10, 2019

(54) Method And Test Bench For Carrying Out A Test Run For A Test Specimen

(71) Applicant: AVL LIST GmbH, Graz (AT)

(72) Inventor: Reinhard Merl, Gratwein-Straßengel (AT)

(21) Appl. No.: 15/777,309

(22) PCT Filed: Nov. 21, 2016
(86) PCT No.: PCT/EP2016/078322

§ 371 Date: Aug. 24, 2018

(30) Foreign Application Priority Data
Nov. 19, 2015 (AT) A50987/2015

(51) Int. Cl. G01M 17/007; G01M 13/02

(52) U.S. Cl. CPC G01M 17/007; G01M 13/025

(57) ABSTRACT

In order to make it possible to simply carry out a realistic test on a vehicle or a sub-system of the vehicle including a control unit that processes the sensor values of a measured quantity , on a test bench, and taking into account the state of the vehicle dynamics, the control unit is switched into a testing mode in order to carry out the test run. Calculated values of the same measured quantity are calculated in a simulation unit and the calculated values of the measured quantity are supplied to the control unit in addition to the detected sensor values of the measured quantity. In testing mode, the control unit ignores the detected sensor values of the measured quantity and omits the plausibility check of the calculated values of the measured quantities.

### TECHNICAL FIELD

The present teaching relates to a method for carrying out a test run on a test bench for a test specimen, at least one measuring sensor being arranged on the test specimen, which sensor detects sensor values of a measured quantity that are supplied to a control unit of the test specimen, and in which sensor the detected sensor values of the measured quantity are processed in accordance with a plausibility check in order to control a function of the test specimen. The present teaching further relates to a corresponding test bench and a control unit of a vehicle for carrying out the method.

### BACKGROUND

Drivetrain test benches or test benches for entire vehicles are often used in the development of vehicles or vehicle components. In the case of a drivetrain, the drivetrain is arranged on the test bench and is connected to one or more load machines (dynamometers). The propulsion system of the drivetrain, e.g. an internal combustion engine and/or an electric motor, then works on the test bench counter to the load machine in order to test various loading states. A drivetrain test bench of this kind is known from DE 10 2008 041 883 A1 for example. A test bench for an entire vehicle may be a conventional roller type test bench, in which the driven vehicle wheels are arranged on test rollers that are driven by a load machine. A conventional roller type test bench of this kind is known for example from DE 100 51 353 A1 or WO 2009/121805 A1. However, test benches are also known, in particular for four-wheel drive vehicles, in which the vehicle wheels are removed and fastened to the load machine directly at the wheel hubs or by means of specific test wheels. A test bench of this kind is known for example from DE 10 2010 017 198 A1 or AT 512 428 B1. Actual road travel of the vehicle can be simulated, in the form of a test run, in a very realistic manner on test benches of this kind in order to test a specific behavior of the vehicle.

In modern vehicles, a combination of control devices is generally used to monitor and control the various functions of the vehicle. In this case, the control devices are interconnected by means of a vehicle bus, such as a CAN bus, and also mutually exchange data, such as measured quantities or controlled variables. In this case, it is also possible for a first control device to carry out a plausibility check on a measured quantity or controlled variable received from a second control device, optionally also using further received measured quantities and/or controlled variables. If the received measured quantities or controlled variables do not appear to be plausible, an error state is entered which usually allows only restricted operation of the vehicle. It is often the case, however, that not all the necessary or expected measured quantities or controlled variables are available or plausible on a test bench. An example of this is when not all the axles of the vehicle are driven, as is often the case on a roller type test bench for example. However, a plurality of control devices monitor measured quantities of all vehicle axles using various measuring sensors. If, in the process, a rotating or stationary axle is detected, which is not plausible, this generally leads to an error state that usually allows only restricted operation of the vehicle.

An error state of this kind is usually undesirable on a test bench, since, after all, the normal functionality of the vehicle is intended to be tested on the test bench.

In order to prevent this, it is already known, for example, to switch the control devices of the vehicle into a special testing mode in which specific control devices are deactivated or measured quantities of specific sensors installed in the vehicle are ignored. DE 10 2007 025 125 B3 describes, for example, a rolling mode in which a roll stabilization controller is switched off and the evaluation of a longitudinal acceleration system, and an axle slippage function, is deactivated in the transmission controller. Realistic test runs which are intended to incorporate the state of the vehicle dynamics of the vehicle cannot be achieved in this manner, however. Instead, a simple test of the vehicle, such as in a workshop or at the end of production (known as end-of-line testing) can be carried out thereby.

In the case of modern vehicles, however, the state of the vehicle dynamics, in particular accelerations, such as transverse or longitudinal accelerations or yaw rates, are also often evaluated and used to control the vehicle or sub-systems of the vehicle. Various driving assistance systems, such as dynamic stability control (ESP), or the torque distribution according to the acceleration state in a four-wheel drive system are mentioned here by way of example. However, a test bench naturally lacks accelerations of this kind, since the vehicle or the test specimen in general is stationary while the test run is being carried out on the test bench. Functions of the vehicle that are influenced by the state of the vehicle dynamics therefore cannot be easily tested on the test bench.

Solutions for this have also already been proposed, such as described in WO 2011/151240 A1. In this case, variables of the state of the vehicle dynamics are simulated in a model and fed back to the vehicle electronics by means of emulation of individual signals. The control devices of the vehicle thus do not process measured quantities detected by a sensor, but instead values that are calculated in an external simulation and fed back. The problem in this case is that the actual sensors on the test bench have to be removed, or deactivated in another manner, for this purpose, since contradictory and competing sensor signals would otherwise be supplied to the control devices, which leads, at best, to another error state on account of a lack of plausibility. Irrespective thereof, this procedure is also extremely complex and so disadvantageous for this reason too.

### SUMMARY

An object of the present teaching is therefore that of specifying a method and a corresponding test bench that makes it possible to realistically test a vehicle or a sub-system of the vehicle on a test bench and taking account of the state of the vehicle dynamics, in a simple manner. In the same way, another object of the present teaching is that of specifying a control unit of a vehicle that makes it possible to implement the method.

This object is achieved according to the present teaching in that the control unit is switched into a testing mode for carrying out the test run, calculated values of the same measured quantity being calculated in a simulation unit and the calculated values of the measured quantity being supplied to the control unit in addition to the detected sensor values of the measured quantity, and, in testing mode, the control unit ignoring the detected sensor values of the measured quantity and omitting the plausibility check of the calculated values of the measured quantities. Intervention in the measuring sensors on the test bench is therefore not required. The measuring sensors simply deliver their detected sensor values to the control unit, which nonetheless identifies that the sensor values are not to be processed. Instead, the calculated values of the same measured quantity are processed, although said values are not checked for plausibility, in order to prevent error states on the test bench owing to implausible values of the measured quantity. In this way, a realistic test run can be implemented on the test bench in a simple manner, which test run can in particular also take account of a state of the vehicle dynamics of the vehicle. Functions can thus be tested on the test bench which otherwise could not easily be tested.

### BRIEF DESCRIPTION OF THE DRAWINGS

The present teaching will be described in greater detail in the following with reference to FIGS. 1 to 3, which schematically show non-limiting, advantageous embodiments of the present teaching by way of example. In the drawings:

FIG. 1 shows an example of a test bench comprising a test specimen for carrying out a test run,

FIGS. 2 and 3 show embodiments according to the present teaching of a control unit and the connection thereof to the test bench.

### DETAILED DESCRIPTION

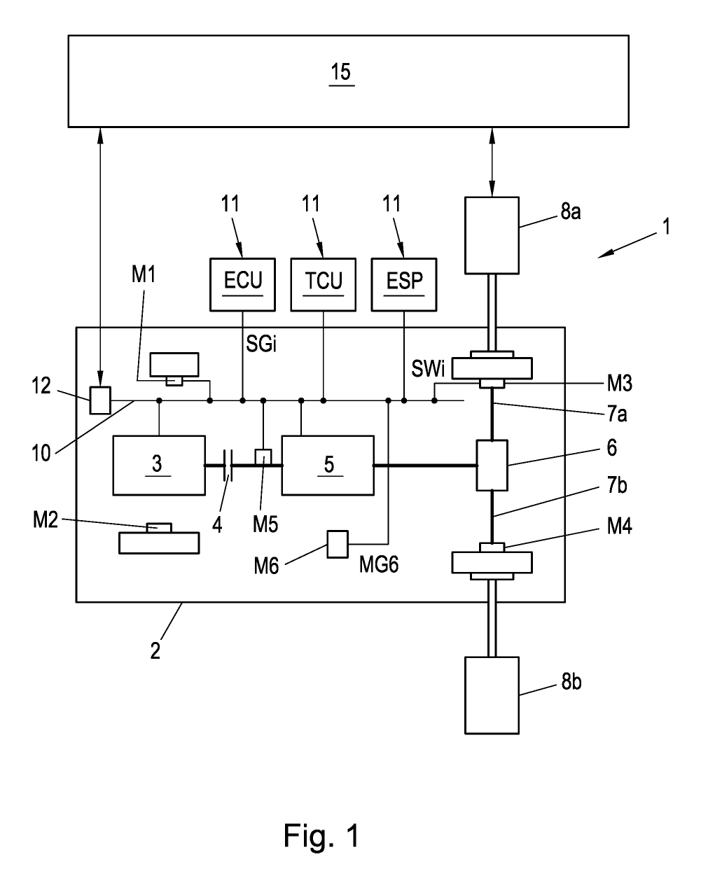

FIG. 1 shows a test bench 1 for a test specimen 2, in this case a vehicle, in a well-known arrangement. The test specimen 2 comprises a propulsion system 3, in this case an internal combustion engine for example, that is connected to a transmission 5 by means of a clutch 4. The transmission 5 is connected to a differential 6 which in turn drives two half-axles 7a, 7b of the vehicle 2. Load machines 8a, 8b are arranged on the driven half-axles 7a, 7b of the vehicle 2. In the same way, just the drivetrain could be provided as the test specimen 2, for example comprising the internal combustion engine, clutch 4, transmission 5, differential 6 and half-axles 7a, 7b, or in any other desired combination, in particular also as a hybrid drivetrain. Likewise, the driven vehicle wheels could be arranged on test bench rollers of a roller type test bench.

The test specimen 2 further comprises a vehicle bus 10, for example a CAN, LIN or FlexRay bus. A plurality of measuring sensors Mi, i=1, . . . , x are arranged in the test specimen 2, again in a well-known manner, which sensors each detect sensor values SWi, i=1, . . . , x of specific measured quantities MGi, i=1, . . . , x. FIG. 1 shows measuring sensors M1, M2, M3, M4, M5, and M6. In addition, a plurality of control units 11, for example an engine control unit ECU, a transmission control unit TCU, and a dynamic stability control system ESP, are also provided in the test specimen 2, which control units are shown outside the test specimen 2 in FIG. 1 simply for reasons of clarity. In the embodiment shown, the measuring sensors Mi transmit the detected sensor values SWi of the measured quantities MGi via the vehicle bus 10. The control units 11, and optionally also other units of the vehicle 2, can read out the sensor values SWi of the measured quantities MGi from the vehicle bus 10 and can process said values in order to carry out a specific, intended function, for example adjusting a throttle valve position or an injection quantity of the internal combustion engine, or gear shifting, or braking, etc. In the same way, in the embodiment shown, the control units 11 transmit controlled variables SGi, i=1, . . . , y for specific vehicle components via the vehicle bus 10, from where the vehicle components read out and process the controlled variables SGi. It is also possible, however, for specific measuring sensors Mi to be connected to specific control units 11 directly and/or for specific control units 11 to be connected to associated vehicle components directly, and not via the vehicle bus 10.

FIG. 1 shows a few measuring sensors Mi and control units 11, simply by way of example. Of course, a plurality of further and/or other measuring sensors Mi and control units 11 may be provided in one vehicle, but this is irrelevant for the following description of the present teaching.

In addition, a test bench automation unit 15 is provided on the test bench 1, which unit controls the test procedure on the test bench 1. The test bench automation unit 15 in particular controls the load machine(s) 8a, 8b and also the test specimen 2, in the form of the vehicle or a vehicle component. For this purpose, the test bench automation unit 15 may be connected to the load machines 8a, 8b. Likewise, for this purpose, the test bench automation unit 15 is connected to the test specimen 2, for example by means of a conventional vehicle diagnostic interface 12, which is in turn connected to the vehicle bus 10. The test bench automation unit 15 could also be connected to other actuators on the test bench 1, for example to a robot driver for actuating the pedals, the steering system or the transmission. The test bench automation unit 15 can, however, also transmit control commands to the relevant control units 11 via the vehicle bus 10, for example transmit a gas pedal position to the engine control unit ECU.

In a vehicle, each control unit 11 expects specific measured quantities MGi. If these measured quantities MGi are missing during operation of the vehicle, an error state is assumed. It is likewise conventional for the control units 11 to check the plausibility (in the sense of checking for correctness or reliability) of received sensor values SWi of measured quantities MGi in a normal mode of the control unit 11, optionally also using other sensor values of other measured quantities MGi. A plausible combination of the signals of an acceleration sensor, of the steering angle, and of the vehicle yaw rate is cited as an example. A plausibility check may be carried out in a different manner for each measured quantity MGi. In general, however, it is known which other measured quantities MGi and/or controlled variables SGi a specific measured quantity depends on, and which sensor values SWi the measured quantities MGi can assume, optionally depending on other measured quantities MGi or controlled variables SGi. The plausibility check is normally permanently implemented in the control unit 11. If the plausibility of the sensor value SWi cannot be checked, this also generally triggers an error state. Error states of this kind are undesirable while the vehicle 2 is being tested on the test bench 1, since it makes it impossible or harder to carry out a realistic test on the vehicle 2, at least for specific functions of the vehicle 2.

In particular, the test bench is naturally lacking measured quantities MGi of the state of the vehicle dynamics of the test specimen 2, i.e. in particular current accelerations, such as longitudinal or transverse acceleration, yaw rate, which are detected using a number of measuring sensors M6 for the vehicle dynamics. However, measured quantities MGi of vehicle control means, such as a steering angle, are generally missing on the test bench 1. In the same way, measured quantities MG1, MG2, for example rotational speeds, of measuring sensors M1, M2 of non-driven axles of the vehicle 2 may also be missing. However, missing sensor values SWi of this kind of specific measured quantities MGi result, in the combination of control units 11, in problems or in undesired behavior. For example, a dynamic stability control system ESP reacts differently in the case of straight travel (steering angle zero) than in the case of a specific steering angle. A rotational speed of zero for one axle may signal to the dynamic stability control system ESP that there is a blocking wheel, resulting in a corresponding undesired reaction of the dynamic stability control system ESP on the test bench 1. Specific functions of the test specimen 2 cannot be tested at all on the test bench 1 without corresponding measured quantities MGi. For example, functions that are dependent on the state of the vehicle dynamics of the vehicle 2, such as dynamic stability control ESP, a torque distribution in a four-wheel drive vehicle, or the control of a hybrid drivetrain, cannot be easily tested on a conventional test bench 1 for these reasons. The present teaching is intended to help in this case, as will be described in the following.

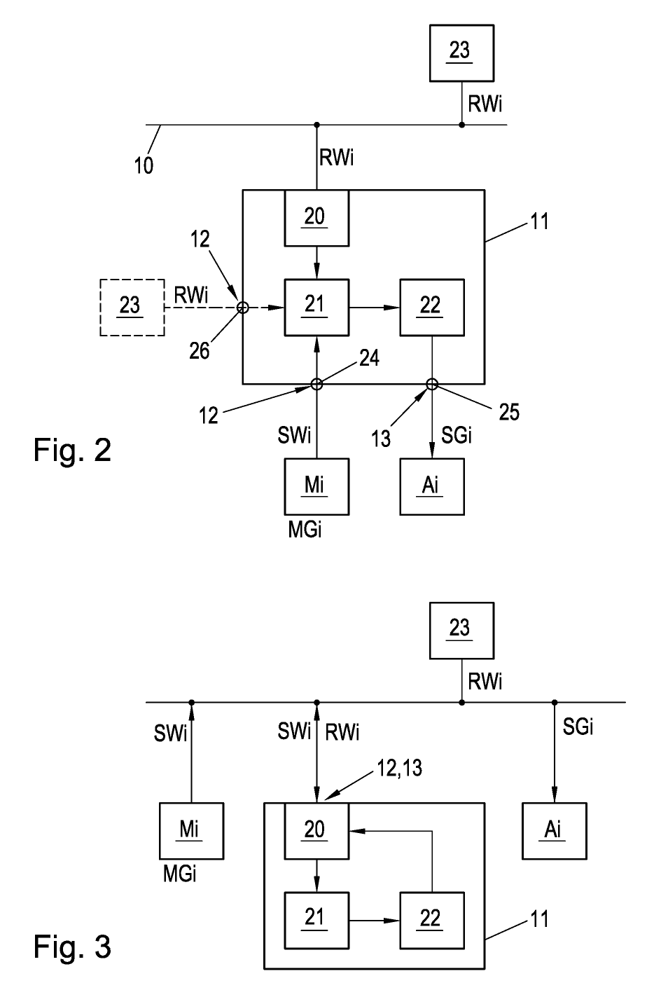

In the embodiment according to FIG. 2, a control unit 11 receives detected sensor values SWi of a specific measured quantity MGi, via a data input 12, from a measuring sensor Mi connected thereto. The data input 12 may be a sensor input 24 to which the measuring sensor Mi can be directly connected. The plausibility of the sensor values SWi is checked in a plausibility check unit 21 and, if they are plausible, said values are processed in a calculation unit 22 in accordance with a specified function of the control unit 11. The control unit 11 calculates a controlled variable SGi which can be output at a data output 13 of the control unit 11. The data output 13 may be a control output 25 of the control unit 11, to which an associated actuator Ai of the vehicle 2 can be connected. The actuator Ai is controlled using the output controlled variable SGi. In this case, the plausibility check unit 21 and calculation unit 22 can of course also be implemented in a single unit and can be configured in the form of hardware and/or software. The embodiment according to FIG. 3 corresponds to that of FIG. 2, the only difference being that the control unit 11 is connected to the vehicle bus 10 via a communication unit 20 and receives the sensor values SWi and transmits the controlled variables SGi via the vehicle bus 10 and the communication unit 20. The data input 12 and the data output 13 of the control unit 11 are therefore formed on the vehicle bus 10 by the communication unit 20 for connecting the control unit 11.

If the measuring sensor Mi does not deliver any sensor values SWi of the measured quantity MGi, or delivers values that are incorrect for the test run, which is ascertained in the plausibility check unit 21, this may disrupt the test run to be carried out or even make said test run impossible. Therefore, according to the present teaching, calculated values RWi of the measured quantity MGi calculated in a simulation unit 23 are determined. In this case, the simulation unit 23 may also be implemented in the test bench automation unit 15. This can take place in accordance with the specifications of the test run, for example on the basis of a simulation of the movement of the vehicle which in particular comprises the state of the vehicle dynamics of the vehicle. The simulation can be carried out using suitable simulation models for example, and may also process other detected sensor values SWi that are transmitted via the vehicle bus 10 for example. In this way, calculated values RWi of measured quantities MGi such as accelerations, steering angle, wheel speeds, etc. can be determined on the test bench 1, which quantities would occur during actual travel of the vehicle but cannot be detected on the test bench 1. Said calculated values RWi are also supplied to the control unit 11 via the data input 12, and preferably via the vehicle bus 10, to which the simulation unit 23 is connected, and the communication unit 20. The calculated values RWi could, however, also be supplied directly to the control unit 11 via a provided second sensor input 26 of the control unit 11 as the data input 12, as indicated in FIG. 2. This would, however, necessitate a direct connection between the simulation unit 23 and the second sensor input 24. The control unit 11 thus simultaneously receives sensor values SWi of the measured quantity MGi detected by the measuring sensor Mi, and computed calculated values RWi of the same measured quantity MGi. Such competing and generally contradictory values of the same measured quantity MGi would stand out in the plausibility check in the plausibility check unit 21, and would lead to an undesired error state.

In order to prevent this, the control unit 11 is switched into a testing mode for the test run on the test bench 1. This may be carried out, for example, by means of a specified combination, known to the vehicle manufacturer only, of specific operating elements of the test specimen 2, or by setting a specific coding value in a diagnostic software. In the same way, this could also be carried out by means of a specific command that is transmitted from the test bench automation unit 15 to the vehicle bus 10 via the vehicle diagnostic interface 12 and is read by all the connected control units 11.

In testing mode, in order to implement the intended function of the control unit 11, the control unit 11 is instructed to ignore the sensor values SWi of the measured quantity MGi received from the measuring sensor Mi and to instead process the calculated values RWi of the measured quantity MGi in order to determine the controlled variable SGi. For this purpose, the calculated values RWi may be transmitted from the simulation unit 23 to the vehicle bus 10 in the form of special messages, in order to allow the control unit 11 to differentiate between the sensor values SWi and the calculated values RWi. It is thus not necessary for the measuring sensor Mi to be dependent on the vehicle bus 10 or the control unit 11 or to be deactivated in another manner. There is therefore no need for any intervention on the test specimen 2 on the test bench 1.

In order to prevent plausibility checks that may be intended in the control unit 11, in testing mode the control unit 11 at the same time omits the plausibility check on the calculated values RWi and trusts the received calculated values RWi. In this case “omit” may mean that no plausibility check is carried out at all, or that the result of the plausibility check is ignored. If the control unit 11 were to check the plausibility of the calculated values RWi of the measured quantity MGi for example using other, actual sensor values SWi of other measured quantities MGi detected on the test bench 1 (which are transmitted to the vehicle bus 10 for example), then the calculated values RWi may, in some circumstances, not stand up to such a check, which could again result in an error state. This can be prevented only by the testing mode.

Although the procedure according to the present teaching has been described only with reference to one measured quantity MGi, the method can of course be applied simultaneously to a plurality of and also to different measured quantities MGi. Likewise, one control unit 11 can also process a plurality of sensor values SWi and/or calculated values RWi and/or calculate and output a plurality of controlled variables SGi.

The software of the control unit 11 has to be adapted accordingly in order to allow a testing mode of this kind on the test bench 1. This may also be the case in a series version of the control unit 11 which may be used in the case of a production vehicle. It is optionally also possible for the control unit 11 or the software of the control unit 11 to simply be exchanged on the test bench 1 in order to be able to work on the test bench 1 using a control unit 11 having a testing mode.

1. A method for carrying out a test run on a test bench for a test specimen, at least one measuring sensor being arranged on the test specimen, which sensor detects sensor values of a measured quantity that are supplied to a control unit, of the test specimen, and in which control unit the detected sensor values of the measured quantity are processed in accordance with a plausibility check in order to control a function of the test specimen, wherein the control unit is switched into a testing mode for carrying out the test run, in that calculated values of the same measured quantity are calculated in a simulation unit and the calculated values of the measured quantity are supplied to the control unit in addition to the detected sensor values of the measured quantity, and in that, in testing mode, the control unit ignores the detected sensor values of the measured quantity and omits the plausibility check of the calculated values of the measured quantities.

2. The method according to claim 1, wherein the calculated values are supplied to the control unit via a vehicle bus connected thereto.

3. A test bench for carrying out a test run using a test specimen including a control unit, at least one measuring sensor being arranged on the test specimen, which sensor detects sensor values of a measured quantity and supplies said values to the control unit, a plausibility check unit, in which the plausibility of the sensor values is checked in a normal mode, being provided in the control unit, and the control unit processing the detected sensor values of the measured quantity in accordance with a plausibility check in order to control a function of the test specimen, wherein a testing mode is implemented in the control unit in order to carry out the test run, in that a simulation unit is provided on the test bench, which unit calculates calculated values of the same measured quantity and supplies said values to the control unit in addition to the detected sensor values of the measured quantity, and in that, in testing mode, the control unit ignores the detected sensor values of the measured quantity and omits the plausibility check of the calculated values of the measured quantities.

4. The test bench according to claim 3, wherein the control unit and the simulation unit are connected to a vehicle bus and the simulation unit transmits the calculated values of the measured quantity to the control unit via the vehicle bus.

5. A control unit of a vehicle including a data input via which a sensor value of a measured quantity detected by a measuring sensor of the vehicle can be supplied during operation of the vehicle, a plausibility check unit, in which the plausibility of the sensor values is checked in a normal mode, being provided in the control unite, and the control unit processing the detected sensor values of the measured quantity, depending on the plausibility check, into a controlled variable for controlling a function of the vehicle or a vehicle component, and including a data output, via which the controlled variable can be output during operation of the vehicle, wherein a testing mode is implemented in the control unit, in testing mode the control unit ignoring detected sensor values of the measured quantity supplied via the data input and processing computed controlled variables of the same measured quantity supplied via the data input without checking the plausibility of the calculated values of the measured quantity in a plausibility check unit of the control unit.
